(19) United States
(12) Patent Application Publication
(10) Pub. No.: US 2002/0139647 A1
(43) Pub. Date: Oct. 3, 2002

(54) Sensor with controlled surface conductivity

(76) Inventor: Jonathan J. Bernstein, Medfield, MA (US)

Correspondence Address: Mark G. Lappin, McDERMOTT, WILL & EMERY, 28 State Street, Boston, MA, 02109, US

(21) Appl. No.: 09/820,542

(22) Filed: Mar. 29, 2001

(51) Int. Cl. H01H 35/02

(52) U.S. Cl. 200/61.49; 200/181

(57) ABSTRACT

Charge transient errors in an inertial sensor are substantially reduced, by forming an ion-implanted, conductive layer on a surface of a dielectric substrate. The substrate has at least two electrodes disposed thereon, and includes a plurality of alkali atoms dispersed near the substrate surface. A proof mass having a conductive, planar surface is supported relative to the substrate, so that the conductive surface of the proof mass is opposite to and nominally parallel with the substrate surface between the electrodes. A plurality of ions are implanted near the substrate surface and between the electrodes. The implantation dose is sufficient to decrease a resistivity of the ion-implanted layer from a relatively high, substantially ion-based resistivity to a relatively low, substantially electron-based resistivity, and to reduce the charge transient time constant of the sensor to the order of milliseconds.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

This invention relates generally to controlling surface conductivity, and more particularly to using ion implantation to control surface conductivity in dielectric substrates so as to eliminate dielectric charging effects in sensors and other instruments.

### BACKGROUND OF THE INVENTION

High precision inertial sensors, such as accelerometers, are widely used for both commercial and military purposes, including aircraft navigation and missile guidance. Because of cost-effectiveness and reduced size, it is advantageous to fabricate inertial sensors using microelectromechanical (MEMS) techniques. MEMS sensors are fabricated using silicon micromachining techniques and wafer bonding techniques known in the semiconductor industry.

In MEMS sensors, the substrate is commonly constructed from dielectrics such as glass. The atomic structure of glass is thought to consist of oxygen, and other network-forming atoms such as Si, B, and Al. Because of their high electrical resistivity and chemical inertness, oxide glasses are widely used as insulators, in the form of substrates and vacuum envelopes.

Anodic bonding is frequently used for bonding silicon to dielectrics such as glass, during the fabrication of micromachined sensors. As known in the art, alkali ions in the glass are thermally activated during anodic bonding, and the thermally activated ions drift in an applied electric field. The glasses used to fabricate accelerometers and gyroscopes using anodic bonding thus contain high concentrations of alkali ions.

Currently, the performance of MEMS sensors is limited by the motion of the alkali ions within the dielectric, which causes dielectric charging effects in the dielectric substrates. Because these alkali ions are somewhat mobile even at room temperature, ionic currents flow -through the dielectric material between the metal electrodes on the dielectric substrate, when a voltage is applied. As a result, undesirable charging effects occur in the dielectric substrate due to the presence of these alkali ions, which is necessary for the anodic bonding process. The ionic glass surface also attracts adsorbed water, resulting in surface ionic currents.

Because of dielectric charging, space charge buildup occurs at the electrodes. Some of these space charges are mirrored in the silicon proof masses, resulting in slowly drifting electrostatic forces that cannot be distinguished from input accelerations. The performance of MEMS sensors is thus impaired.

Several methods have been used in the prior art to reduce ionic charging effects in glass substrates. One method consists of using AC excitation or commutation on accelerometers and gyroscopes. By using frequent polarity reversals, ionic charging is reduced. AC excitation and commutation require, however, greater complexity in the readout and rebalance electronics of many MEMS sensors. This significantly adds to the cost and complexity of the final product. For many programs that require inertial instruments, implementing commutation is expensive, and would lead to significant delays.

Another method in the prior art involves covering all exposed glass with multiple metal and dielectric layers, so that no glass is exposed. This requires an extra metal and dielectric layer to be added to the process, and has proven difficult to implement. The use of multiple metal layers and inter-metal dielectric adds to the complexity of fabrication, increasing manufacturing costs and reducing yield.

Currently, the large charge transients cause about 1% of accelerometer drift, with time constants ranging from minutes to hours. Dielectric charging effects have also been found to cause gyroscope scale factor transients, bias, and variation of scale factor and bias with temperature.

It is an object of this invention to provide an apparatus and method in which charge transient errors caused by dielectric charging effects are significantly reduced, without incurring the above-discussed disadvantages associated with prior art methods. It is another object of the present invention to use ion implantation in order to significantly reduce charge transient errors in MEMS sensors.

### SUMMARY OF THE INVENTION

The present invention uses ion implantation to substantially reduce charge transient effects in inertial sensors, such as MEMS accelerometers and gyroscopes, and in other devices such as high value resistors in electronic circuits. An ion-implanted conductive layer is formed on the surface of a dielectric substrate in the sensor or other device. Because of ion implantation, the resistivity of the ion-implanted conductive layer is reduced by several orders of magnitude. As a consequence, the charge transient relaxation time is significantly reduced.

The present invention relates to a system for substantially reducing charge transient effects in a device includes an element having an electrically conductive, substantially planar surface. In a preferred embodiment, the device is an inertial sensor, and the element is a proof mass. The system further includes a dielectric substrate having a substantially planar surface. At least two electrodes are disposed on this surface. A plurality of charged alkali atoms are dispersed near the planar surface of dielectric substrate and between the electrodes. A support structure supports the proof mass relative to the dielectric substrate, so that the conductive surface of the element is opposite to and nominally parallel with the surface of the dielectric substrate between the electrodes. In one embodiment, the support structure is a suspension assembly that flexurally supports the proof mass relative to the substrate.

A plurality of ions are implanted near the surface of the dielectric surface and between the electrodes so as to form an ion-implanted layer. The implantation dose of the plurality of ions is selected to be sufficient to decrease a resistivity of the ion-implanted layer from a relatively high, substantially ion-based resistivity to a relatively low, substantially electron-based resistivity. The implantation dose of the plurality of ions is also selected to be sufficient to substantially reduce charge transient effects caused by the drifting motion of the charged alkali atoms when a voltage is applied between the electrodes, for example during an anodic bonding process. Because of the implanted ions, image charges are formed locally within the ion-implanted layer, so that the image charges on the proof mass surface are substantially reduced.

In an exemplary embodiment, the resistivity of the ion-implanted conductive layer on the dielectric substrate is reduced from about 10¹² ohms to about 10⁹ ohms, when the implantation dose is selected to have a value ranging from about 1×10⁵ atoms/cm² to about 8×10¹⁵ atoms/cm². At these ion-implantation doses, the charge transient effects are reduced from hours and minutes to milliseconds. The charge transient relaxation time thus falls outside of the output bandwidth of the inertial sensor. The performance of the inertial sensor is therefore substantially improved.

### BRIEF DESCRIPTION OF THE DRAWINGS

FIG. 1 is a schematic block diagram of an overview of the main elements of the present invention, in which an ion-implanted conductive layer is formed on a dielectric substrate in order to reduce charge transient errors in a device.

FIG. 2(a) illustrates the layout of an inertial sensor chip.

FIG. 2(b) illustrates a metal layer from the inertial sensor chip illustrated in FIG. 2(a), showing the exposed glass between the metal lines.

FIG. 3 illustrates space-charge buildup in a glass substrate for an inertial sensor, as occurs in the prior art.

FIG. 4 illustrates an ion-implanted, electrically conductive layer that is formed on a glass substrate in an inertial sensor constructed according to the present invention.

FIG. 5 illustrates the change in the surface conductivity of glass, when glass is implanted with carbon at various concentrations.

### DETAILED DESCRIPTION

The present invention relates to an apparatus and method for modifying the surface electronic conductivity of the dielectric chips from which MEMS inertial sensors are fabricated, so as to substantially reduce the charge transient instabilities caused by dielectric charging effects. Currently, the performance of MEMS inertial sensors such as accelerometers and gyroscopes is limited by charge transients, which typically are 1% of full scale acceleration, and last for hours. Gyroscope scale factor and bias, and variation of scale factor and bias with temperature, are all strongly affected by dielectric charging effects. In the present invention, an ion-implanted conductive layer is formed on the surface of the dielectric chip from which a MEMS inertial sensor is fabricated. This ion-implanted layer allows ionic charges to be locally mirrored within the layer, thereby preventing image or mirror charges from forming on the surface of the proof mass of the sensor. Charge transient relaxation time is substantially reduced, and the long, slow drift which currently limits the performance of the inertial sensors is substantially eliminated.

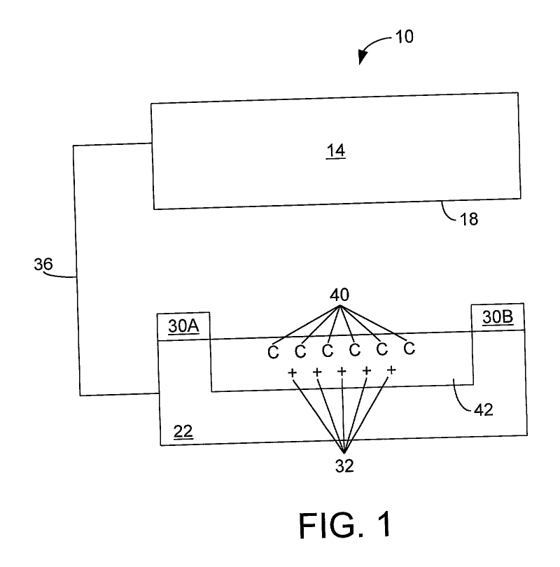

FIG. 1 is a schematic block diagram of an overview of some of the elements of a preferred embodiment of the present invention. An inertial sensor 10 includes a proof mass 14 having an electrically conductive, substantially planar surface 18. A substrate 22 is made of a dielectric material, and has a substantially planar surface 26. In a preferred embodiment, the dielectric material is glass. The substrate 22 has at least two electrodes 30A and 30B, disposed on the surface 26. The substrate 22 includes a plurality of charged alkali atoms 32, such as Na+, K⁺, and Li⁺, dispersed near the surface 26 of the dielectric substrate 22 between the electrodes 30A and 30B. A support structure 36 flexurally supports the proof mass 14 relative to the dielectric substrate 22, so that the conductive surface 18 of the proof mass 14 is opposite to and nominally parallel with the substrate surface 26 between the electrodes, when the proof mass 14 is in equilibrium. A plurality of ions 40 are implanted near the surface 26 of the dielectric substrate 22 and between the electrodes, so that an ion-implanted conductive layer 42 is formed on the dielectric surface 26. The ions 40 may include, but are not limited to, metallic ions. The ions 40 may include, but are not limited to, carbon ions, tin ions, ruthenium ions, and indium ions. The implanted ions 40 cause the resistivity of the layer 42 to drop considerably, typically from about 10¹² ohms to about 10⁹ ohms. As a consequence, the charge transient time constant for the sensor 10 drops from hours and minutes to the order of milliseconds.

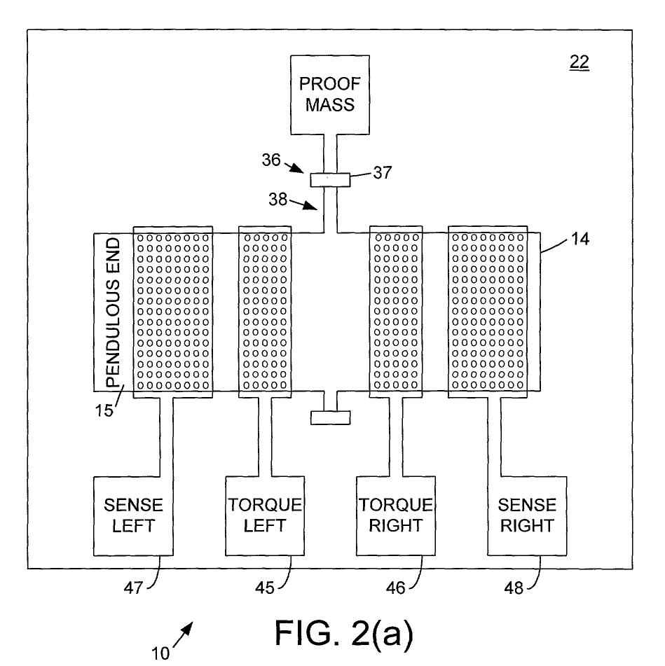

FIG. 2(a) illustrates the overall layout of a MEMS inertial sensor 10. In the illustrated embodiment, the inertial sensor 10 is a pendulous accelerometer known in the art, and is fabricated on a chip. A proof mass 14 is flexurally supported relative to a dielectric substrate 22 by means of a support structure 36, such as a suspension assembly 36 shown in FIG. 2(a). The suspension assembly 36 includes a proof-mass anchor 37 coupled to a torsional flexure 38.

A dissolved wafer process is implemented for fabricating the inertial sensor 10 shown in FIG. 2(a). In a dissolved wafer fabrication process, a surface of a silicon wafer is patterned and etched to form mesas which act to define an electrode to proof mass gap. This surface is doped with high concentration boron to define the thickness of the proof mass 14. The surface is then patterned and etched, typically by reactive ion etching, to define the perimeter of the sensor. The patterned surface may include a plurality of finger-like members. The surface is then bonded to the dielectric substrate 22 that contains metallized electrodes, for example by an anodic bonding process. The undoped and lightly doped portions of the silicon wafer are removed by anisotropic etching, leaving the proof mass 14 suspended over the electrodes and attached to the dielectric substrate 22 in the mesa areas.

As a result of the dissolved wafer process, the proof mass 14 forms a seesaw-like suspended structure over four electrodes 45, 46, 47 and 48, and includes a pendulous end 15. The four electrodes consist of a left 45 and a right 46 drive electrode for providing a torque to the proof mass 14, and a left 47 and a right 48 sense electrode for sensing the resulting torsional motion of the proof mass 14.

FIG. 2(b) shows only a metal layer 52 from the inertial sensor chip illustrated in FIG. 2(a), with the proof mass 14 and the torsional flexure 38 removed. The metal layer 52 includes a ground plane electrode 54 which surrounds the active electrodes 45, 46, 47 and 48. As shown in FIG. 2(b), exposed glass 56 is found between the metal lines. The exposed glass 56 results from lithography limitations, which cause a gap 60 to be left between the active electrodes 45-48 and the ground plane 54, with exposed glass 56 in the gap 60.

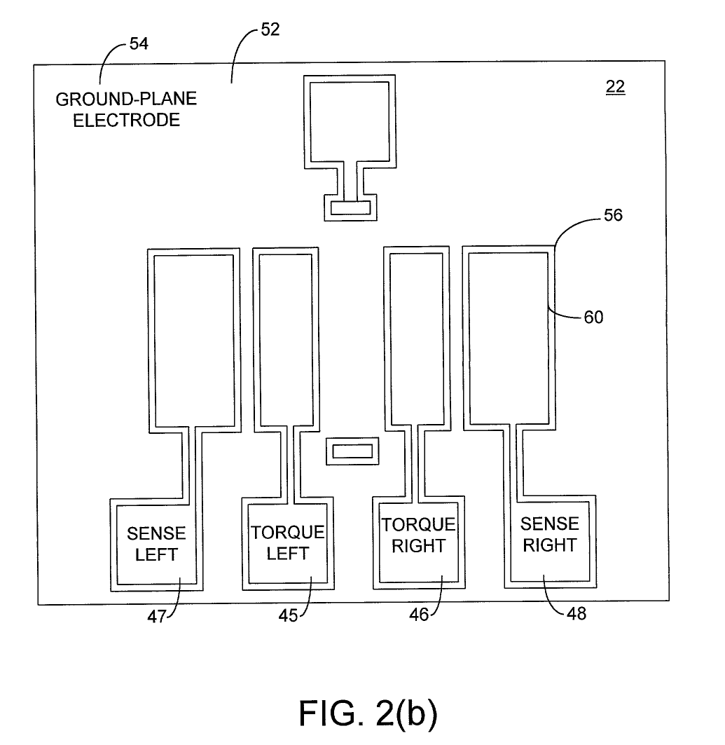

FIG. 3 illustrates space-charge buildup in a glass substrate, and the formation of image charges 64 on the proof mass surface 18, as occur in the prior art. FIG. 3 shows a cross-section from the inertial sensor chip illustrated in FIGS. 2(a) and 2(b), showing a small region around one of the exposed glass gaps 60 shown in FIG. 2(b). Two metal electrodes 70 and 72 are disposed on the dielectric substrate 22 and under the proof mass 14, with an applied potential difference between the two electrodes.

Space-charge buildup is caused by mobile alkali ions 32 in the glass forming the dielectric substrate 22. Because of their high electrical resistivity and chemical inertness, oxide glasses are widely used as a preferred dielectric material for the dielectric substrate in MEMS devices. The motion of alkali ions, in particular sodium ions, is the primary mechanism of ionic conduction in oxide glasses. Even in fused silica that contains only a few parts per million of sodium ions, conductivity is still dominated by those alkali ions.

Anodic bonding is commonly used to bond an etched surface of a silicon wafer to a dielectric substrate. Anodic bonding of glass to silicon is known in the art, and increasingly used for bonding and/or lamination of wafers. Typically, glasses used in anodic bonding have a thermal expansion coefficient matched to that of silicon. Examples of such glasses are Pyrex 7740, TEMPAX, and SD2. During anodic bonding, the silicon wafer is typically placed together with the glass substrate on a heated chuck, after the wafers are well aligned and placed in contact with each other. When the two-wafer structure is heated to a temperature in the range of 300 to 450 degrees Celsius, positive ions, such as the charged alkali atoms dispersed within the glass in the glass substrate, become mobile and will drift under the influence of an electric field. The high temperature and the electric field cause a strong, permanent bond to be formed between the silicon and the glass.

A key mechanism in anodic bonding is the thermal activation of the alkali ions within glass, and the drift of the alkali ions in an applied electric field. As a consequence, the glasses used to fabricate inertial sensors, such as the MEMS accelerometer shown in FIGS. 2(a) and 2(b), contain high concentrations of alkali ions, for example Na⁺, K⁺, and Li⁺. Unfortunately, the motion of these alkali ions within the glass causes glass charging effects in the glass substrate, as explained below, thereby seriously impairing the performance of the MEMS sensor 10 (shown in FIGS. 2(a) and 2(b)).

Although the alkali ions 32 dispersed within the glass substrate 22 are necessary in order for anodic bonding to occur, these alkali ions are somewhat mobile even at room temperature. As a consequence, when a voltage is applied between the metal electrodes 70 and 72, ionic currents are formed by the motion of the alkali ions, and flow through the glass between the electrodes. Because there are no electrochemical reactions which can occur at the electrodes to neutralize the sodium ions, these ionic currents result in the buildup of space charges 80 at the electrodes 70 and 72, as shown in FIG. 3. Space charges 80 also builds up on the glass surface 26 under the proof mass 14 away from the metal electrodes 70 and 72, because of the capacitance between the proof mass 14 and the glass substrate 22. Some of these space charges 80 are mirrored in the silicon proof mass, i.e., equal and opposite image charges 64 are induced on the proof mass surface 18.

These charges 80 and 64 form slowly, with long time constants (minutes to hours), due to the high resistance of glass. This results in slowly drifting electrostatic forces between the charged glass and the induced charges 64 on the silicon proof mass 14. These electrostatic forces are substantially indistinguishable from input inertial forces, leading to slow drift and bias errors in the inertial sensor 10.

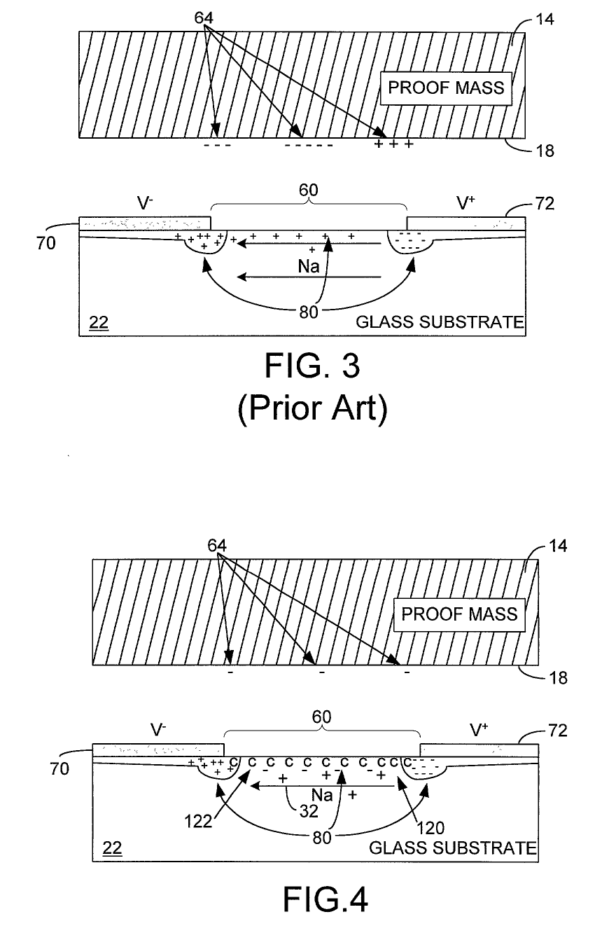

FIG. 4 illustrates an ion-implanted conductive layer 120 that is formed on a glass substrate 22, in an inertial sensor constructed in accordance with the present invention. Various charged atoms such as carbon, tin, ruthenium, indium, or other ions can be implanted to form this conductive layer 120. The conductivity of the layer must be controlled to yield a resistance on the order of 1 to 10 G-ohm, in order to yield the desired time constant for charge transients. This resistance is so large that there is no deleterious effect on the operation of the sensor 10, other than a very slight increase in noise current at the proof mass pickoff node.

Ion implantation is a technique well known in the art for doping a wafer surface, so as to create N-type or P-type pockets in the wafer surface. During ion implantation, dopant atoms are ionized, accelerated to a high speed, then physically shot into a wafer surface or onto a near-surface region of solids. When ions of sufficient energy are directed toward a wafer surface, they will penetrate the surface and slow down to rest within the solid. One advantage of the ion implantation process is the possibility of precisely controlling the type and amount of impurity to be introduced.

FIG. 4 illustrates a row of implanted carbons that form an ion-implanted conductive layer 120 on the dielectric substrate 22. It is known that the surface conductivity of dielectrics can be increased by high dose ion implantation of a conductive species, such as C⁺. Studies have shown that the surface conductivity of fused quartz can be controllably and radically increased by C⁺ ion implantation, when implanted above a certain critical dose.

In the present invention, the implantation dose of the ions is chosen to have at least a threshold value sufficient to decrease a resistivity of the ion-implanted layer 120 from a relatively high, substantially ion-based resistivity, to a relatively low, substantially electron-based resistivity. In an exemplary embodiment, the threshold value may range from about 1×10¹⁵ atoms/cm² to about 8×10¹⁵ atoms/cm². In one embodiment, the relatively low resistance may be about 10⁹ ohms, and the relatively high resistance may be about 10¹² ohms. In a preferred embodiment, the threshold value is also sufficient to cause the charge transient time constant of the inertial sensor to be reduced to a desired, predetermined value that falls outside of the output bandwidth of the inertial sensor. The predetermined value is typically of the order of milliseconds.

One of the benefits that occur upon formation of the ion-implanted conductive layer 120 in the inertial sensor 10 is that the RC time constant for capacitively induced charge drops from minutes and hours to milliseconds. With this short time constant, the charge transients do not show up in the inertial sensor output, which is band-limited to typically 100 Hz. In other words, the fast charge transients no longer fall within the bandwidth of the sensor output.

Another benefit resulting from the formation of the ion-implanted layer is that the space charges 80 due to the ionic currents are now mirrored locally in the ion-implanted, conductive layer 120. In other words, the implanted ions are adapted to induce the formation of local image charges 122 within the ion-implanted layer 120, so that the image charges 64 that would have been formed on the proof mass surface, in the absence of the implanted ions, are substantially reduced. This reduction of image charges on the proof mass surface has not been achieved in the prior art.

In the embodiment illustrated in FIG. 4, test structures consisting of metal inter-digitated electrodes were fabricated on glass, followed by a carbon implant and an anneal simulating the anodic bonding process. The depth of the ion-implanted layer could be controlled as a function of the implantation energy of the ions. C⁺ ions were implanted at 100 keV, which put them at about 0.56+/−0.14 microns below the surface.

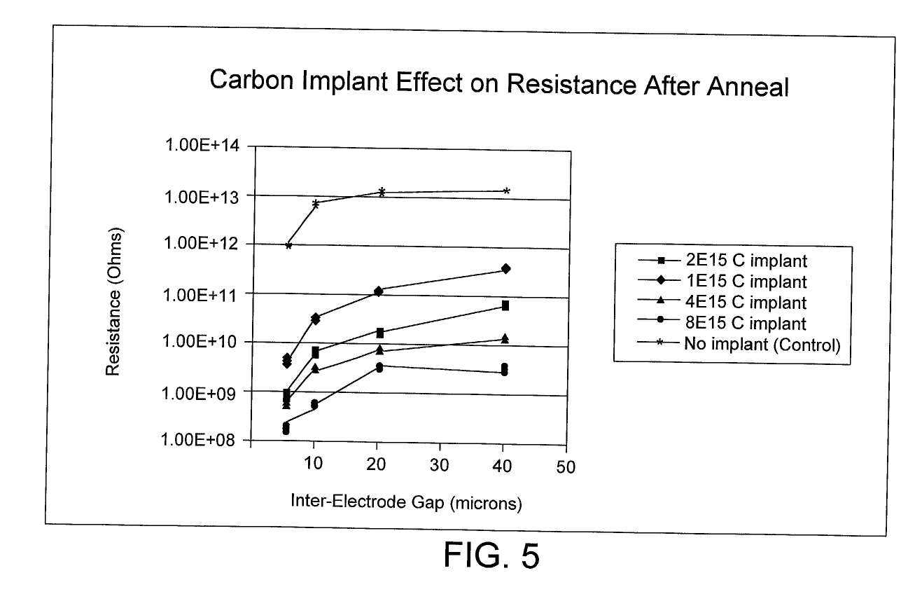

FIG. 5 illustrates the change in the surface conductivity of glass, when glass is implanted with carbon at various concentrations. The surface conductivity is plotted in FIG. 5 for glass samples implanted with carbon at 10¹⁵, 2×10¹⁵, 4×10¹⁵, and 8×10¹⁵ atoms/cm², respectively. The surface conductivity of a control wafer, which has no implanted ions, is also shown. The resistance in ohms is shown on a logarithmic scale. Three data values were taken for each implant and inter-electrode gap. The electrical conductivity was successfully modulated into the desired range for millisecond time constants.

FIG. 5 shows that the implantation of carbon ions can dramatically increase the conductivity of glass. This dramatic increase in conductivity is due to the close proximity of the conducting atoms (or clusters) within the dielectric that is possible at this dose. As seen from FIG. 5, it is possible to select an implantation dose that yields a desired conductivity of the dielectric material.

The current invention uses ion-implantation to create an electrically conductive layer on the surface of the exposed glass in sensors such as accelerometers and gyroscopes, so as to reduce charge transient errors by several orders of magnitude. Charge transient errors are reduced using a single, high yield step that can be added to the standard fabrication process flow, with minimal cost. The ion-implant method of the present invention provides a surface layer of precisely controlled conductance. This layer is just under the surface, at a depth controlled by the energy of the ion implant. The implanted layer is permanent, and is not a chemical coating which can evaporate, peel, or cause sticking. The ion implant is inexpensive, and a blanket implant can be applied with no additional photosteps. If desired, the implant can be masked from some areas with one additional photolithography step.

The current invention provides for the manufacture of improved MEMS devices, including but not limited to accelerometers and gyroscopes. Errors in gyroscope scale factor and bias, caused by glass charging effects, as well as temperature-dependent variation of scale factor and bias, are substantially reduced in the improved MEMS devices. This invention can benefit other processes for MEMS devices, including polysilicon surface micromachining processes in which dielectric charging effects are also troublesome. This invention can also be used to form high value resistors in circuits that need them, such as static RAM, or analog MOS pre-amplifiers.

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. An inertial sensor comprising:
A. a proof mass having an electrically conductive, substantially planar surface;
B. a substrate made of a dielectric material and having a substantially planar surface, said substrate having at least two electrodes disposed on said surface, said substrate further including a plurality of charged alkali atoms dispersed at least in proximity to said substrate surface and between said electrodes; and
C. a structure for supporting said proof mass relative to said substrate whereby said electrically conductive surface of said proof mass is opposite to and nominally parallel with said substrate surface between said electrodes;
wherein said substrate has a plurality of ions implanted at least in proximity to said substrate surface and between said electrodes so as to form an ion-implanted layer.

2. An inertial sensor according to claim 1, wherein the implantation dose of said plurality of ions is selected to have at least a threshold value sufficient to decrease a resistivity of said ion-implanted layer from a relatively high resistivity to a relatively low resistivity.

3. An inertial sensor according to claim 2, wherein said relatively high resistivity is a substantially ion-based resistivity, and said relatively low resistivity is a substantially electron-based resistivity.

4. An inertial sensor according to claim 2, wherein said threshold value is between about 1×10¹⁵ atoms/cm² to about 8×10¹⁵ atoms/cm².

5. An inertial sensor according to claim 1,
wherein a motion of said charged alkali atoms, in response to a voltage applied between said at least two electrodes, is capable of causing a capacitive build-up of space charges in said substrate in proximity to each of said at least two electrodes, and is capable of forming equal and opposite image charges on said proof mass surface, whereby the electrostatic forces between said space charges and said image charges are sufficient to cause charge transient effects substantially indistinguishable from inertial input forces to be sensed by said sensor;
and wherein said plurality of implanted ions are adapted to induce the formation of local image charges within said ion-implanted layer so as to substantially reduce said image charges formed on said proof mass surface.

6. An inertial sensor according to claim 5, wherein the implantation dose of said plurality of implanted ions is selected to have at least a threshold value, said threshold value being sufficient to cause a charge transient time constant of said sensor to be reduced to a predetermined value.

7. An inertial sensor according to claim 6, wherein the inverse of said predetermined value falls outside of an output bandwidth of said inertial sensor.

8. An inertial sensor according to claim 7, wherein said predetermined value is about 10⁻³ seconds.

9. An inertial sensor according to claim 1, wherein said plurality of implanted ions comprise electronically conductive ions and metallic ions.

10. An inertial sensor according to claim 1, wherein said plurality of implanted ions are selected from the group consisting of carbon ions, tin ions, ruthenium ions, and indium ions.

11. An inertial sensor according to claim 1, wherein said sensor is a MEMS (microelectromechanical) sensor.

12. An inertial sensor according to claim 1, wherein said relatively low value is about 10⁹ ohms.

13. An inertial sensor according to claim 1, wherein said relatively high value is about 10¹² ohms.

14. An inertial sensor according to claim 1, wherein said structure includes a suspension assembly.

15. An inertial sensor according to claim 1, wherein the depth of the ion-implanted layer is a function of the implantation energy of said plurality of ions.

16. An inertial sensor comprising:
A. a proof mass having an electrically conductive, substantially planar surface;
B. a substrate made of a dielectric material and having a substantially planar surface, said substrate having at least two electrodes disposed on said surface, said substrate further including a plurality of alkali atoms dispersed at least in proximity to said substrate surface and between said electrodes; and
C. a structure for flexurally supporting said proof mass relative to said substrate whereby said electrically conductive surface of said proof mass is opposite to and nominally parallel with said substrate surface between said electrodes;
wherein said substrate has a plurality of ions implanted at least in proximity to said substrate surface and between said electrodes so as to form an ion implanted layer within said substrate, the implantation dose of said ions being sufficient to cause the resistivity of said layer to decrease from a relatively high, substantially ion-based resistivity to a relatively low, substantially electron-based resistivity value.

17. A method for reducing charge transient effects in an inertial sensor, said inertial sensor including a proof mass having an electrically conductive, substantially planar surface, said inertial sensor further including a dielectric substrate having a substantially planar surface and at least two electrodes disposed on said surface, said dielectric substrate including a plurality of charged alkali atoms dispersed at least in proximity to said substrate surface and between said electrodes, said method comprising:
providing a structure for supporting said proof mass relative to said substrate so that said electrically conductive surface of said proof mass is opposite to and nominally parallel with said substrate surface between said electrodes; and
implanting a plurality of ions at least in proximity to said substrate surface and between said electrodes so as to form an ion-implanted layer;
wherein an implantation dose of said ions is selected to have a value greater than a threshold value sufficient to decrease a resistivity of said ion-implanted layer from a relatively high, substantially ion-based resistivity value to a relatively low, substantially electron-based resistivity value.

18. A method according to claim 17, wherein a motion of said charged alkali atoms between said at least two electrodes is capable of inducing image charges on said surface of said proof mass, and wherein said plurality of implanted ions are capable of forming local image charges within said ion-implanted layer so as to substantially reduce said image charges formed on said proof mass surface.

19. A system for reducing dielectric charging effects in a device, said system comprising:
A. an element having an electrically conductive, substantially planar surface;
B. a dielectric member including a substantially planar surface, said dielectric member having at least two electrodes disposed on said surface of said member, said dielectric member further including a plurality of charged alkali atoms dispersed at least in proximity to said surface of said dielectric member and between said electrodes; and
C. a support structure for supporting said element relative to said dielectric member, whereby said electrically conductive surface of said element is opposite to and nominally parallel with said surface of said dielectric member between said electrodes;
wherein said dielectric member has a plurality of ions implanted at least in proximity to said surface of said dielectric member and between said electrodes so as to form an ion-implanted layer.

20. A system according to claim 19, wherein the implantation dose of said plurality of ions is selected to have at least a threshold value whereby a resistivity of said ion-implanted layer decreases from a relatively high, substantially ion-based resistivity to a relatively low, substantially electron-based resistivity.

21. A system according to claim 20, wherein a motion of said charged alkali atoms between said at least two electrodes is capable of inducing image charges on said surface of said element, and wherein said plurality of implanted ions are capable of forming local image charges within said ion-implanted layer so as to substantially reduce said image charges formed on said proof mass surface.

22. A system according to claim 19, wherein said dielectric member includes a dielectric substrate.

23. An inertial sensor according to claim 1, wherein said structure is adapted to flexurally support said proof mass relative to said substrate.
